(19) United States
(12) Patent Application Publication
(10) Pub. No.: US 2005/0175127 A1
(43) Pub. Date: Aug. 11, 2005

(54) Method for determining the phase-and/or amplitude-noise spectrum of a digitally modulated signal

(75) Inventors: Christoph Balz, Muenchen (DE); Martin Hofmeister, Muenchen (DE)

Correspondence Address: FITZPATRICK CELLA HARPER & SCINTO, 30 ROCKEFELLER PLAZA, NEW YORK, NY, 10112, US

(73) Assignee: Rohde & Schwarz GmbH & Co. KG, Muenchen (DE)

(21) Appl. No.: 11/097,229

(22) Filed: Apr. 4, 2005

Related U.S. Application Data
(63) Continuation of application No. PCT/EP03/10326, filed on Sep. 17, 2003.

(30) Foreign Application Priority Data
Oct. 4, 2002 (DE) 102 46 316.6

(51) Int. Cl. H04L 25/08

(52) U.S. Cl. 375/346

(57) ABSTRACT

A method for determining the phase and/or amplitude noise spectrum of a digitally modulated input signal. The method for determining a phase-noise spectrum comprises generating real complex samples, by digitally sampling a phase component and phase quadrature component of the input signal in baseband, determining ideal complex samples from generated real samples, establishing complex quotients from the real and ideal complex samples, generating modified complex quotients by assigning the value 1 to the complex quotients, and subjecting the modified complex quotients to a Fourier transform. The invention also concerns a similar method for determining the amplitude noise spectrum of the digitally modulated input signal.

### CROSS REFERENCE TO RELATED APPLICATIONS

This is a Continuation of International application PCT/EP03/10326, filed on Sep. 17, 2003, and published in German but not English as WO 2004/034630 A1 on Apr. 22, 2004, the priority of which is claimed herein (35 U.S.C. §120) and which claims priority of German Application No. 102 46 316.6, filed Oct. 4, 2002, the priority of which is also claimed herein (35 U.S.C. §119).

### BACKGROUND OF THE INVENTION

1. Field of the Invention

The invention relates to a method for determining the phase-noise spectrum and/or amplitude-noise spectrum of a digitally modulated signal.

2. Description of the Related Art

For the analysis and technical measuring evaluation of digitally modulated signals, the graphic representation of the phase-noise spectrum and of the amplitude-noise spectrum of the oscillators involved in the signal processing is an important measurement quantity. Such a measurement is particularly important in the case of digital transmission of television signals which are for example QAM (Quadrature Amplitude Modulation)-modulated or mVSB (Vestigial SideBand)-modulated.

The digitally modulated signals are processed as a rule without residual carriers or with only a small residual carrier. The effective spectrum of the modulated signal extends over a relatively large bandwidth. The spectrum of the phase-noise to be measured or of the amplitude-noise to be measured is however also situated in this effective spectrum of the modulated signal. In order to measure the spectrum of the phase-noise or of the amplitude-noise, it has been normal to date to switch off the modulation and to transmit a continuous CW (Continuous Wave) signal. This CW signal can then be tested by means of a spectrum analyzer and the phase-noise spectrum or amplitude-noise spectrum can be detected, although there still exists a difficulty in this method of separating the phase-noise from the amplitude-noise. A simultaneous transmission of data is not possible in this operating state which serves for measuring the phase- or amplitude-noise. This is however disadvantageous since the normal operation must be interrupted for the measurement, which is not possible during service measurements in operating transmission mode.

A method for determining the reference phase on an 8VSB or 16VSB signal emerges from U.S. Pat. No. 6,366,621 B1. It is proposed in this publication to reconstruct the pilot signal by computer. A measurement of short-term phase fluctuations (phase jitter) and in particular a measurement of the spectrum which extends over the spectrum of effective data is not possible with this method.

### SUMMARY OF THE INVENTION

An object of this invention is to make possible a determination of the phase-noise spectrum and/or of the amplitude-noise spectrum of a digitally modulated signal during normal modulation operation without the modulation requiring to be switched off.

The object is achieved with respect to determination of the phase-noise spectrum by the features of claim 1 and with respect to determination of the amplitude-noise spectrum by the features of claim 2.

The knowledge underlying the invention is that the spectrum of effective data, which is superimposed upon the spectrum of the phase-noise or amplitude-noise to be measured can be calculated in that the measured, real, complex samples (respectively with an in-phase component (I) and a quadrature phase component (Q)) are related to the ideal complex samples. The consequently arising phase difference or the therefrom arising amplitude ratio between measured, real, complex samples and ideal, complex samples arising due to the modulation are the still present modulation-corrected phase fluctuations or amplitude fluctuations which form the modulation-corrected measurement quantity.

Since the phase fluctuations or amplitude fluctuations are related to the modulation-conditioned given ideal baseband signal, the thus detected phase fluctuations or amplitude fluctuations are completely independent of the just transmitted modulation signal. Hence the operation need not be interrupted. For example, the phase-noise spectrum or amplitude-noise spectrum on a television transmitter can be measured without the programme which is transmitted by the television transmitter requiring to be interrupted.

The reference to the ideal baseband signal can be produced in a simple manner by quotient formation from the measured, real, complex samples and the ideal, complex samples extracted therefrom. By forming the quotient, there is produced on the one hand the phase difference between the real complex samples and the ideal complex samples. On the other hand, the amplitude ratio of the values of the real complex samples and of the ideal complex samples is produced. In the case of determination of the phase-noise spectrum, the value of the quotient should be set at one. In the case of determination of the amplitude-noise spectrum, the phase of the coefficient should be set at zero. After implementing a Fourier transform, the corresponding spectrum is present.

Claims 3 to 7 include advantageous developments of the invention.

If the signal to be tested is an mVSB signal, then it is useful to determine only the in-phase component of the ideal samples from the real samples, and in fact from the in-phase component thereof. The quadrature phase component of the ideal samples is produced from the in-phase component of the ideal samples, then by the Hilbert transform underlying this single side-band modulation type.

In particular when evaluating mVSB signals, it is advantageous to replace the complex quotient of real and ideal samples by interpolation values if the permissible value range is exited, in particular when the value of the real sample falls below a first threshold value or the imaginary part of the real sample is greater than a second threshold value or smaller than a third threshold value.

Claims 8 to 11 relate to a digital storage medium, a computer program or a computer program product for implementing the method according to the invention.

### BRIEF DESCRIPTION OF THE DRAWINGS

An embodiment of the invention is described in more detail subsequently with reference to the drawings. There are shown in the drawings:

FIG. 1 is a flow diagram for explaining the method according to the invention for determining the phase-noise spectrum;

FIG. 2 is a flow diagram for explaining the method according to the invention for determining the amplitude-noise spectrum;

FIG. 3 is a real constellation diagram of an 8VSB signal which is disturbed by a phase jitter;

FIG. 4 is an ideal constellation diagram associated with FIG. 3;

FIG. 5A is a phase error Δφ as a function of a sample index n;

FIG. 5B is an I/Q diagram of the values of the complex coefficients of real samples and ideal samples, the value=1 having been set;

FIG. 5C is a phase-noise spectrum determined by the method according to the invention;

FIG. 6A is an enlarged section from FIG. 5A;

FIG. 6B is an I/Q diagram associated with FIG. 6A;

FIG. 6C is a phase-noise spectrum which is associated with FIG. 6A and represents an enlarged section from FIG. 5C; and

FIG. 7 is a block diagram for explaining a device for implementing the method according to the invention.

### DETAILED DESCRIPTION OF THE PREFERRED EMBODIMENTS

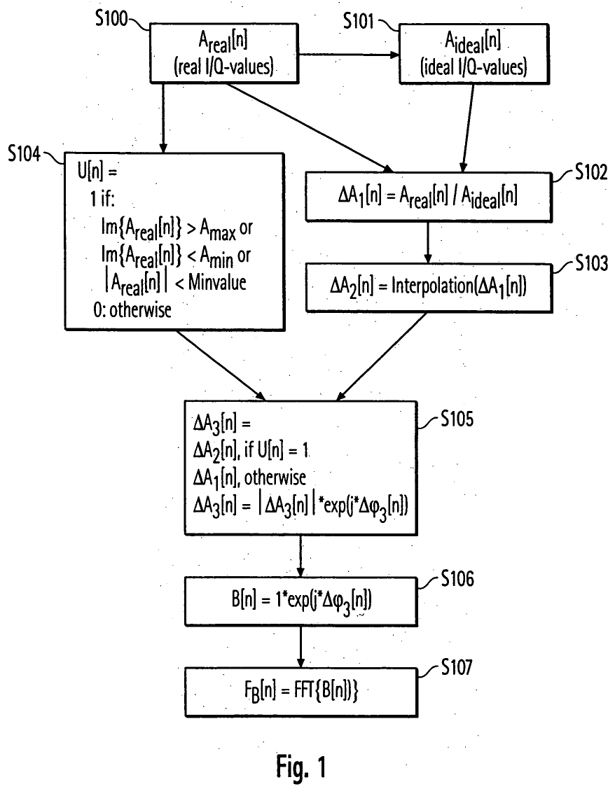

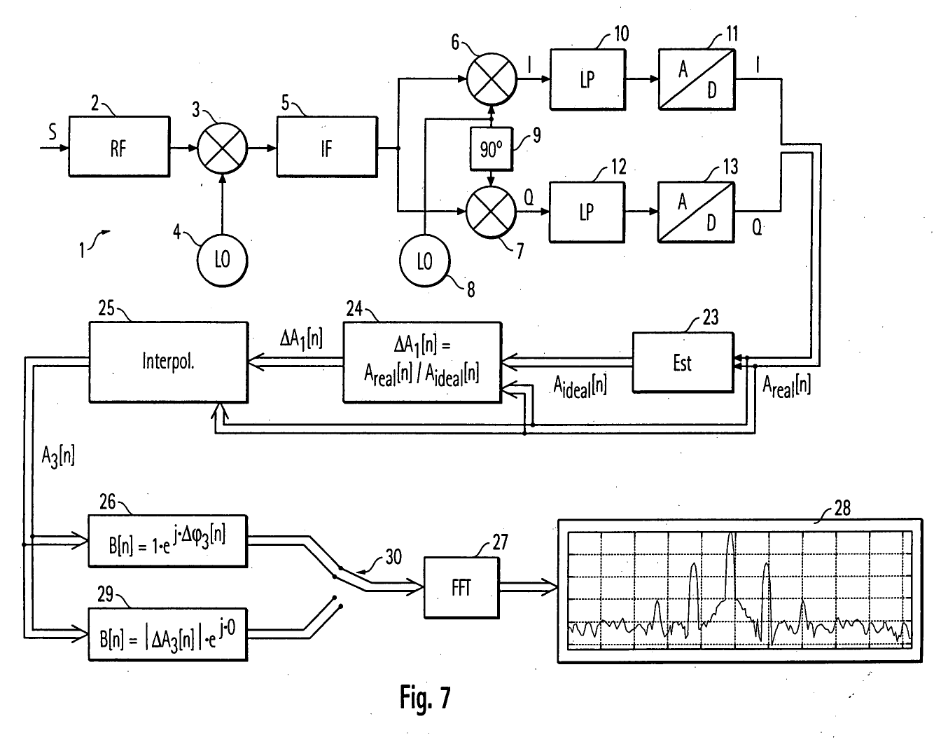

With reference to FIGS. 1 and 7, the method according to the invention and a device for implementing the method according to the invention for determining the phase-noise spectrum of a digitally modulated signal will be explained.

In the case of the device 1 according to the invention and represented in FIG. 7, a digitally modulated high frequency signal S to be analyzed is supplied firstly to a high frequency unit 2. In the normal manner, the signal is mixed downwards via a first mixer 3, which is in communication with a local or variable oscillator 4, to an intermediate frequency and further processed in an intermediate frequency unit 5. The intermediate frequency signal is transformed into the baseband by a second mixer 6 and a third mixer 7. For this purpose, the first mixer 6 is in communication directly with a second local oscillator 8 and the third mixer 7 via a 90° phase shifter 9 with the local oscillator 8. The oscillator signals supplied to the mixers 6 or 7 are therefore phase-shifted relative to each other by 90°. At the output of the second mixer 6, the in-phase component I of the baseband signal arises, said component being supplied via a first low-pass filter 10 to a first analogue/digital converter 11. At the output of the third mixer 7, the quadrature phase component Q of the baseband signal is available, said component being supplied via a second low-pass filter 12 to a second analogue/digital converter 13. At the output of the analogue/digital converters 11 and 13, complex samples Aᵣₑₐₗ[n] are hence available, which represent the complex baseband signal of the input signal S. n is the sample index. The in-phase component I at the output of the first analogue/digital converter 11 represents the real part and the quadrature phase component Q at the output of the second analogue/digital converter 13 represents the imaginary part of these complex samples Aᵣₑₐₗ[n].

It should be noted also that it is a precondition that the baseband signal occurs synchronised with respect to frequency and time.

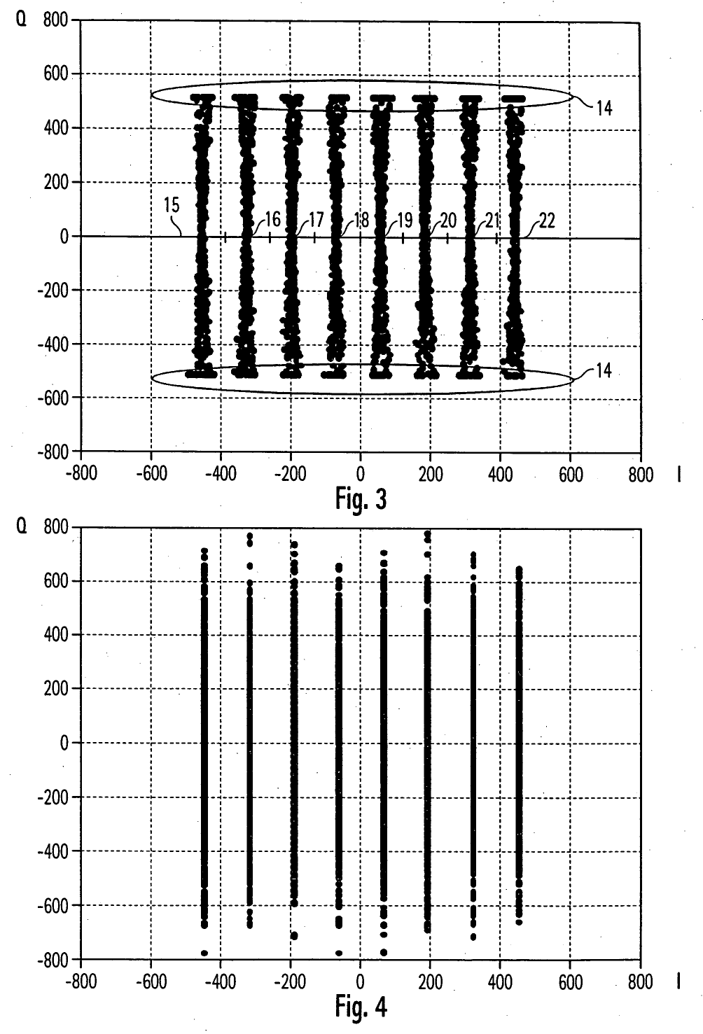

The above described generation of the real complex samples Aᵣₑₐₗ[n] corresponds to the step S100 in the flow diagram of FIG. 1. In the method step S101, ideal complex samples Aᵣₑₐₗ[n] are generated from the real complex samples Aᵣₑₐₗ[n]. For this purpose, entry regions are established in the constellation diagram which assign one specific real I/Q value precisely to one ideal I/Q value. With reference to FIGS. 3 and 4, this is explained by the example of an 8VSB modulation which is used for example for transmitting video signals for digital television.

FIG. 3 shows the constellation diagram of the real complex samples Aᵣₑₐₗ[n]. Fundamentally, the process can take place during the assignment of the real complex samples Aᵣₑₐₗ[n] to the ideal complex samples A_{ideal}[n] such that both the I values and the Q values are taken into account during this assignment and each ideal sample has hence a flat entry region on real samples. This mode of operation is suitable for example in the case of a QAM modulation. In the case of the mVSB modulation occurring in FIG. 3, a different mode of operation is useful: only the real part, i.e. the in-phase component I, of the real samples Aᵣₑₐₗ[n] is evaluated and to each in-phase component I of the real samples Aᵣₑₐₗ[n] respectively one in-phase component I of an ideal sample A_{ideal}[n] is assigned. In FIG. 3, the entry regions of the in-phase component I of the real complex samples Aᵣₑₐₗ[n], which lead respectively to precisely one in-phase component of the ideal samples A_{ideal}[n], are represented by the intervals 15 to 22.

Since each quadrature phase component Q in the case of mVSB modulation can be calculated via a Hilbert transform from the temporally successive series of in-phase components I, it is proposed corresponding to a development according to the invention to obtain the quadrature phase component Q of the ideal samples A_{ideal}[n] not from the quadrature phase component Q of the real samples Aᵣₑₐₗ[n] but instead by calculation from the series of the in-phase component of the ideal samples A_{ideal}[n] via the Hilbert transform.

The thus obtained ideal samples A_{ideal}[n] are illustrated in FIG. 4. It is clear in view thereof that the limitation of the value region present in FIG. 3, which is illustrated with the reference number 14, is no longer present in FIG. 4. Here, corresponding interpolation measures must be, if necessary, still implemented. This is dealt with further on.

The above described generation of the ideal complex samples A_{ideal}[n] from the real complex samples Aᵣₑₐₗ[n] is effected in the assignation device 23 illustrated in FIG. 7. In a quotient formation device 24, the quotient
ΔA₁[n]=Aᵣₑₐₗ[n]/A_{ideal}[n] (1)
i.e. the complex quotient ΔA₁[n] is calculated from the real, complex samples Aᵣₑₐₗ[n] and the ideal complex samples A_{ideal}[n]. This is illustrated in the flow diagram of FIG. 1 by the step S102.

In an optional method step S103, which is effected in the interpolator 25, an interpolation of the complex quotients can be undertaken optionally if the latter are outside a specific value range and are therefore not reliable. If for example the imaginary part Im {Aᵣₑₐₗ[n]} of the real samples Aᵣₑₐₗ[n] is greater than a prescribed maximum, i.e. greater than a threshold value Amax, or else is smaller than a prescribed minimum, i.e. smaller than a prescribed threshold value Aₘᵢₙ, then the quotient ΔA₁[n] can no longer be represented digitally by the number format and these limited values must not be taken into account. These values should rather be replaced by an interpolation from the preceding and/or subsequent values.

The resolution of the I/Q values for determining the quotient ΔA₁[n] is determined by the number of quantization steps of Aᵣₑₐₗ[n]. The relative error of ΔA₁[n] is therefore all the greater, the smaller is the value of Aᵣₑₐₗ[n]. In order to minimize the effect of random errors of this type, preferably values of ΔA₁[n] should likewise be rejected and be replaced by interpolated values if the value is relatively small without the total result being thereby falsified. Therefore an interpolation should preferably also be effected when the value of the real complex samples Aᵣₑₐₗ[n] is smaller than a threshold value Minvalue.

The determination of the above mentioned interpolation criteria is effected in method step S104, the samples affected by the interpolation being marked by a marking (Flag) U[n]. The interpolation values ΔA₂[n] can be calculated in method step S103 for all quotient values ΔA, [n], said quotient values being taken over in method step S105 only when the interpolation marking U[n] is set. The complex (if necessary interpolated) quotients ΔA₃[n] arising after the interpolation can be written in polar coordinates as follows:
ΔA₃[n]=|ΔA₃[n]|·e^{9j·Δφ}^{₃}^{[n])} (2)

According to the invention, a modified complex coefficient B[n] is now generated for the representation of the phase-noise spectrum by setting the value |ΔA₃[n]| of the complex quotient ΔA₃[n] to 1 in step S106 in FIG. 1, in the modification device 26 in FIG. 7:
B[n]=1·e^{(j·Δφ}^{₃}^{[n])} (3)

When determining the phase-noise spectrum, the amplitude fluctuations are not of interest but only the spectrum of the phase fluctuations is of interest. The phase fluctuations are determined by the phase difference Δφ₃[n] because, by means of the quotient formation in step S102, the phase difference Δφ₁[n]=φᵣₑₐₗ−φ_{ideal}, i.e. the difference between the phase φᵣₑₐₗ of the real samples Aᵣₑₐₗ[n] and the phase φ_{ideal} of the ideal samples A_{ideal}[n], arises. Δφ₃[n] differs from Δφ₁[n] only by the if necessary still effected interpolation. An essential discovery according to the invention resides in the fact that the phase fluctuation can be evaluated independently of the momentary phase prescribed by the modulation if, corresponding to the method according to the invention, the modulation-conditioned momentary phase is reconstructed by reconstruction of the ideal samples and the thus reconstructed reference phase φ_{ideal}[n] is withdrawn from the measured actual phase φᵣₑₐₗ[n].

After implementing a Fourier transform in method step S107, in the Fourier transform unit 27, the phase-noise spectrum is present and can be displayed by means of a display device 28, for example a display.

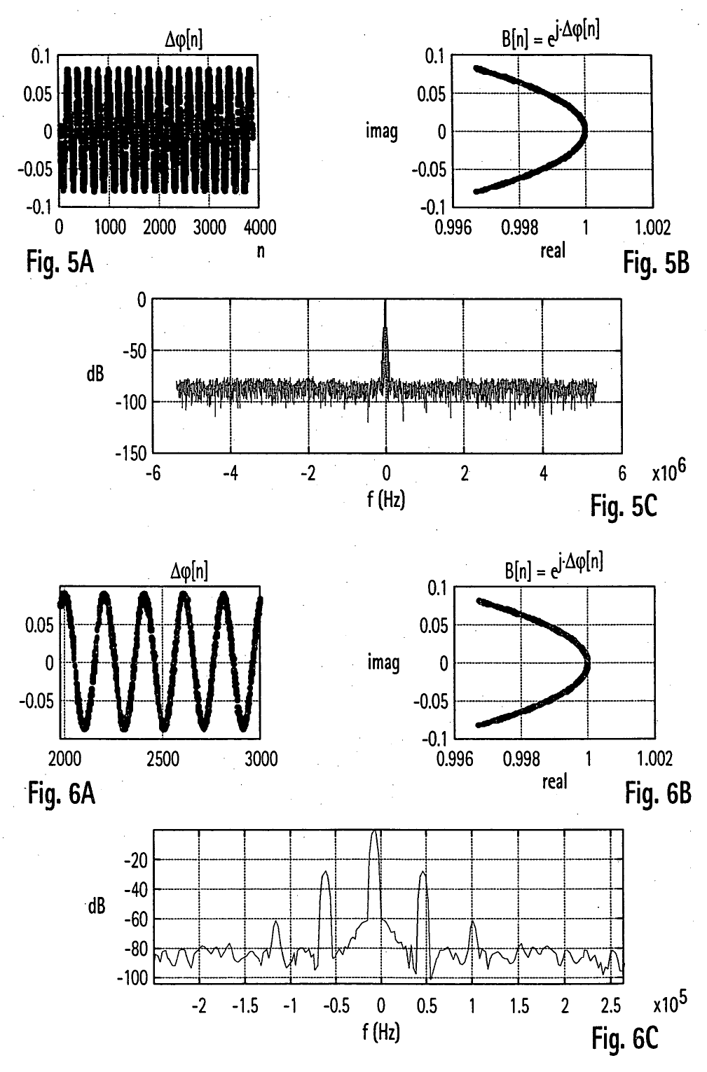

In order to illustrate the invention, an example of a phase fluctuation Δφ[n] is illustrated in FIG. 5A as a function of the sample index n. In FIG. 5B, the associated I/Q diagram of the modified complex coefficient B[n] is illustrated. It is detected that the values B[n] move on a circle with radius unity. In FIG. 5C, the associated phase-noise spectrum, which was determined by the method according to the invention, is illustrated. FIG. 6A shows an enlarged section of FIG. 5A and FIG. 6B shows the corresponding I/Q diagram relating to this section. FIG. 6C shows the phase-noise spectrum which is correspondingly resolved more precisely.

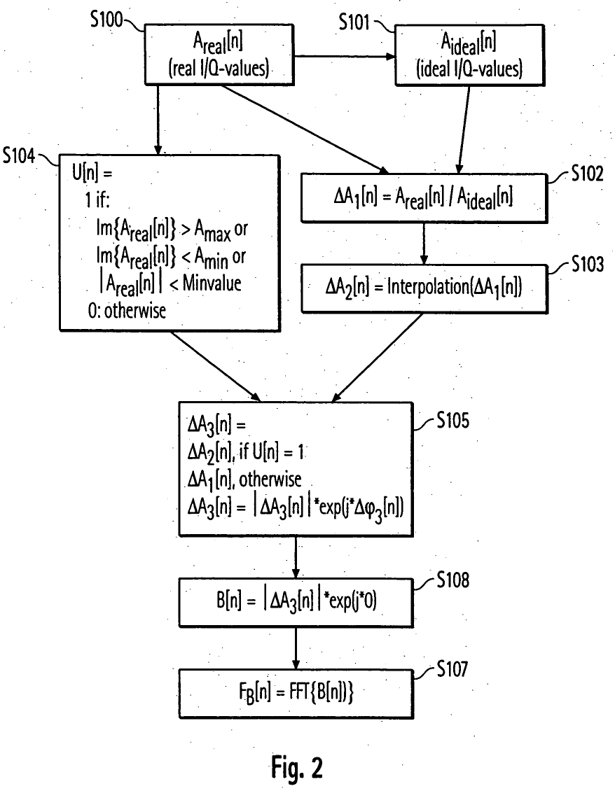

In a similar manner, the amplitude-noise spectrum can also be evaluated. The method steps required for this purpose are illustrated in the flow diagram illustrated in FIG. 2. The method steps S100 to S105 are identical to the method steps S100 to S105 which have already been explained with reference to FIG. 1. In the method step S108 in FIG. 2, deviating from the method step S106 in FIG. 1, modified complex quotients B[n] are generated by setting the phase Δφ₃[n] of the complex quotient Δφ₃[n] to zero.
B[n]=|ΔA₃[n]|·^{ej·0} (4)

In this way, phase fluctuations do not affect the spectrum generated by the Fourier transform in step S107. Instead, the spectrum is characterized by the fluctuations of the value |ΔA₃[n]| of the (if necessary interpolated) quotient ΔA₃[n]. The generation of the modified complex quotients B[n] for the amplitude-noise spectrum is effected in a modification device 29 in FIG. 7. The input signal for the Fourier transform device 27 can be switched via a switch-over device 30 between the modification devices 26 and 29.

Advantageously, the power density per filter bandwidth, the filter bandwidth being a set basic number of the FFT (Fast Fourier Transform) which is used and depending upon the temporal interval of the original I/Q values, can be calculated into another unit, e.g. dBc/Hz, i.e. power density=power per 1 Hz bandwidth). This is particularly useful in the evaluation of noise interferences. In the case of assessment of narrow band interferences (CW interferences), it is sensible to leave the unit of the level axis unchanged. If necessary the desired unit or scaling can be selected with a switch.

The invention is not restricted to the described embodiment. Rather, numerous modifications and improvements are possible within the scope of the invention. For example, when generating the ideal samples A_{ideal}[n] from the real samples Aᵣₑₐₗ[n], the error correction coding which is generally present can also be evaluated, as a result of which the accuracy is further increased because defective allocations to wrong ideal samples A_{ideal}[n] generate erratic phase and/or amplitude fluctuations which are actually not present.

1. A method for determining a phase-noise spectrum of a digitally modulated input signal, the method comprising the steps of:
generating real complex samples (Aᵣₑₐₗ[n]) by digitally sampling an in-phase component and a quadrature phase component of the input signal in a baseband;
determining ideal complex samples (A_{ideal}[n]) from the real complex samples (Aᵣₑₐₗ[n]);
forming complex quotients (ΔA₁[n]=Aᵣₑₐₗ[n]/A_{ideal}[n]) from the real complex samples (Aᵣₑₐₗ[n]) and the ideal complex samples (A_{ideal}[n]);
generating modified complex quotients (B[n]) by setting a value of the complex quotients to 1; and
implementing a Fourier transform with modified complex quotients (B[n]) obtained in the generating of modified complex quotients (B[n]).

2. A method for determining an amplitude-noise spectrum of a digitally modulated input signal, the method comprising the steps of:
generating real complex samples (Aᵣₑₐₗ[n]) by digitally sampling an in-phase component and a quadrature phase component of the input signal in a baseband;
determining ideal complex samples (A_{ideal}[n]) from the real complex samples (Aᵣₑₐₗ[n]);
forming complex quotients (ΔA₁[n]=Aᵣₑₐₗ[n]/A_{ideal}[n]) from the real complex samples (Aᵣₑₐₗ[n]) and the ideal complex samples (A_{ideal}[n]);
generating modified complex quotients (B[n]) by setting a phase of the complex quotients to 0; and
implementing a Fourier transform with modified complex quotients (B[n]) obtained in the generating of modified complex quotients (B[n]).

3. The method according to claim 1 or 2,
wherein the input signal is digitally modulated according to a mVSB method, in particular an 8VSB method.

4. The method according to claim 3,
wherein only an in-phase component of the ideal complex samples (A_{ideal}[n]) is determined from an in-phase component of the real complex samples (Aᵣₑₐₗ[n]), and a quadrature phase component of the ideal complex samples (A_{ideal}[n]) is generated by a Hilbert transform from the in-phase component of the ideal complex samples (A_{ideal}[n]).

5. The method according to claim 1 or 2,
wherein complex quotient (ΔA₁[n]) is replaced by an interpolation value (ΔA₂[n]) when a value of an associated real complex sample (|Aᵣₑₐₗ[n]|) is smaller than a first threshold value (Minvalue).

6. The method according to claim 1 or 2,
wherein complex quotient (ΔA₁[n]) is replaced by an interpolation value (ΔA₂[n]) when an imaginary part of an associated real complex sample (Im{Aᵣₑₐₗ[n]}) is greater than a second threshold value (Aₘₐₓ).

7. The method according to claim 1 or 2,
wherein complex quotient (ΔA₁[n]) is replaced by an interpolation value (ΔA₂[n]) when an imaginary part of an associated real complex sample (Im{Aᵣₑₐₗ[n]}) is smaller than a third threshold value (Aₘᵢₙ).

8. A computer-readable storage medium storing a program, which, when executed, performs a method for determining a phase-noise spectrum of a digitally modulated input signal, the program comprising:
code to generate real complex samples (Aᵣₑₐₗ[n]) by digitally sampling an in-phase component and a quadrature phase component of the input signal in a baseband;
code to determine ideal complex samples (A_{ideal}[n]) from the real complex samples (Aᵣₑₐₗ[n]);
code to form complex quotients (ΔA₁[n]=Aᵣₑₐₗ[n]/A_{ideal}[n]) from the real complex samples (Aᵣₑₐₗ[n]) and the ideal complex samples (A_{ideal}[n]);
code to generate modified complex quotients (B[n]) by setting a value of the complex quotients to 1; and
code to implement a Fourier transform with modified complex quotients (B[n]) obtained by the code to generate modified complex quotients (B[n]).

9. A computer-readable storage medium storing a program, which, when executed, performs a method for determining an amplitude-noise spectrum of a digitally modulated input signal, the program comprising:
code to generate real complex samples (Aᵣₑₐₗ[n]) by digitally sampling an in-phase component and a quadrature phase component of the input signal in a baseband;
code to determine ideal complex samples (A_{ideal}[n]) from the real complex samples (Aᵣₑₐₗ[n]);
code to form complex quotients (ΔA₁[n]=Aᵣₑₐₗ[n]/A_{ideal}[n]) from the real complex samples (Aᵣₑₐₗ[n]) and the ideal complex samples (A_{ideal}[n]);
code to generate modified complex quotients (B[n]) by setting a phase of the complex quotients to 0; and
code to implement a Fourier transform with modified complex quotients (B[n]) obtained by the code to generate modified complex quotients (B[n]).

10. The computer-readable storage medium according to claim 8 or 9,
wherein the input signal is digitally modulated according to a mVSB method, in particular an 8VSB method.

11. The computer-readable medium according to claim 10,
wherein the code to generate ideal complex samples (A_{ideal}[n]) determines only an in-phase component of the ideal complex samples (A_{ideal}[n]) from an in-phase component of the real complex samples (Aᵣₑₐₗ[n]), and generates a quadrature phase component of the ideal complex samples (A_{ideal}[n]) by performing a Hilbert transform from the in-phase component of the ideal complex samples (A_{ideal}[n]).

12. The computer-readable medium according to claim 8 or 9,
wherein the program further comprises code to replace complex quotient (ΔA₁[n]) with an interpolation value (ΔA₂[n]) when a value of an associated real complex sample (|Aᵣₑₐₗ[n]|) is smaller than a first threshold value (Minvalue).

13. The computer-readable medium according to claim 8 or 9,
wherein the program further comprises code to replace complex quotient (ΔA₁[n]) with an interpolation value (ΔA₂[n]) when an imaginary part of an associated real complex sample (Im{Aᵣₑₐₗ[n]}) is greater than a second threshold value (Aₘₐₓ).

14. The computer-readable medium according to claim 8 or 9,
wherein the program further comprises code to replace complex quotient (ΔA₁[n]) with an interpolation value (ΔA₂[n]) when an imaginary part of an associated real complex sample (Im{Aᵣₑₐₗ[n]}) is smaller than a third threshold value (Aₘᵢₙ).

15. A program product stored on a computer-readable storage medium, the program product embodying a program that is executable to perform a method for determining a phase-noise spectrum of a digitally modulated input signal, the program product comprising:
code to generate real complex samples (Aᵣₑₐₗ[n]) by digitally sampling an in-phase component and a quadrature phase component of the input signal in a baseband;
code to determine ideal complex samples (A_{ideal}[n]) from the real complex samples (Aᵣₑₐₗ[n]);
code to form complex quotients (ΔA₁[n]=Aᵣₑₐₗ[n]/A_{ideal}[n]) from the real complex samples (Aᵣₑₐₗ[n]) and the ideal complex samples (A_{ideal}[n]);
code to generate modified complex quotients (B[n]) by setting a value of the complex quotients to 1; and
code to implement a Fourier transform with modified complex quotients (B[n]) obtained by the code to generate modified complex quotients (B[n]).

16. A program product stored on a computer-readable storage medium, the program product embodying a program that is executable to perform a method for determining an amplitude-noise spectrum of a digitally modulated input signal, the program product comprising:
code to generate real complex samples (Aᵣₑₐₗ[n]) by digitally sampling an in-phase component and a quadrature phase component of the input signal in a baseband;
code to determine ideal complex samples (A_{ideal}[n]) from the real complex samples (Aᵣₑₐₗ[n]);
code to form complex quotients (ΔA₁[n]=Aᵣₑₐₗ[n]/A_{ideal}[n]) from the real complex samples (Aᵣₑₐₗ[n]) and the ideal complex samples (A_{ideal}[n]);
code to generate modified complex quotients (B[n]) by setting a phase of the complex quotients to 0; and
code to implement a Fourier transform with modified complex quotients (B[n]) obtained by the code to generate modified complex quotients (B[n]).

17. The program product according to claim 15 or 16,
wherein the input signal is digitally modulated according to a mVSB method, in particular an 8VSB method.

18. The program product according to claim 17,
wherein the code to generate ideal complex samples (A_{ideal}[n]) determines only an in-phase component of the ideal complex samples (A_{ideal}[n]) from an in-phase component of the real complex samples (Aᵣₑₐₗ[n]), and generates a quadrature phase component of the ideal complex samples (A_{idea}[n]) by performing a Hilbert transform from the in-phase component of the ideal complex samples (A_{ideal}[n]).

19. The program product according to claim 15 or 16,
wherein the program product further comprises code to replace complex quotient (ΔA₁[n]) with an interpolation value (ΔA₂[n]) when a value of an associated real complex sample (|Aᵣₑₐₗ[n]|) is smaller than a first threshold value (Minvalue).

20. The program product according to claim 15 or 16,
wherein the program product further comprises code to replace complex quotient (ΔA₁[n]) with an interpolation value (ΔA₂[n]) when an imaginary part of an associated real complex sample (Im {Aᵣₑₐₗ[n]}) is greater than a second threshold value (Aₘₐₓ).

21. The program product according to claim 15 or 16,
wherein the program product further comprises code to replace complex quotient (ΔA₁[n]) with an interpolation value (ΔA₂[n]) when an imaginary part of an associated real complex sample (Im{Aᵣₑₐₗ[n]}) is smaller than a third threshold value (Aₘᵢₙ).
